(19) United States
(12) Patent Application Publication
(10) Pub. No.: US 2010/0176353 A1
(43) Pub. Date: Jul. 15, 2010

(54) Fire retardant composition

(76) Inventor: Rinoud Hanna, Rochester, NY (US)

Correspondence Address: LAW OFFICE OF TRACY P. JONG, 2775 BUFFALO ROAD, SUITE 3, ROCHESTER, NY, 14624, US

(21) Appl. No.: 12/319,744

(22) Filed: Jan. 12, 2009

(51) Int. Cl. C09K 21/02

(52) U.S. Cl. 252/601

(57) ABSTRACT

An environment friendly fire retardant composition comprising an aqueous suspension of a material containing aluminum or a combination of boron and aluminum.

### BACKGROUND OF THE INVENTION

1. Field of the Invention

The present invention relates to a fire retardant composition for controlling the spread of vegetation fires such brush fires and for controlling fires in building structures.

2. Description of the Prior Art

Fire retardants are used either to extinguish fires directly or to form a fire front to contain a burning zone and to prevent it from spreading. Such retardants typically contain compounds of various elements including phosphorus, sulfur, lead, chlorine, bromine, boron and nitrogen. While halogen containing compounds are effective for neutralizing gases needed to sustain fire, such compounds are often toxic or harmful to the environment. Compounds containing boron, sulfur and phosphorus, such as borates, sulfates and phosphates, are also effective fire suppressants but are often toxic in nature or otherwise harmful to the environment. U.S. Pat. No. 4,197,913 (Korenowski) and U.S. Pat. No. 4,272,414 (Vandersall) describe various such suppressants and retardants containing such compounds.

It is therefore an object of this invention to provide a fire retardant composition which has minimal effect on the environment.

It is a further object of this invention to provide a fire retardant composition which efficiently reduces or eliminates the spreading of fires.

It is yet another object of this invention to provide a fire retardant composition which is convenient to transport and use.

It is still another object of this invention to provide a fire retardant composition which is particularly suitable for use in building structure fires and brush fires.

### SUMMARY OF THE INVENTION

These and other objects are accomplished with a novel fire retardant composition that forms a continuous barrier on the surface to which it is applied thereby shielding the surface from fire. The composition comprises an aqueous suspension of material containing from about 2% to about 35% by weight aluminum and boron. The fire retardant composition is conveniently applied as a spray or other suitable type of coating to the area to be protected. It is particularly effective when applied to areas of vegetation such as brush, or to surfaces in building structures. The composition of this invention is environment friendly. While the precise reason is unknown, studies indicate that there is a possibility that boron loses its toxicity when combined with aluminum. Efforts have been made to substitute another element for boron or to eliminate it altogether, however, the resultant compositions are not as effective as a fire retardant as the composition of this invention. The use of aluminum is the inventive composition is particularly suitable since it is the third most abundant element of the earth's crust. In addition to its presence in clays, minerals and rocks, it is also present in natural water as a soluble salt, as well as in colloidal and insoluble compound forms (L. S. Clesceri, A. E. Greenberg and R. R. Trussell, “Standard Methods for the Examination of Water and Waste Water”, 1989, 17th Edition, pp 3-63).

### BRIEF DESCRIPTION OF THE DRAWINGS

FIG. 1 is a plan view of a fire tray used to simulate brush fire conditions in Example 4.

### DETAILED DESCRIPTION OF PREFERRED EMBODIMENTS

The following Examples are provided to further illustrate the present invention.

### EXAMPLES 1, 2 and 3

The series of tests in these Examples demonstrate the fire retardant properties of the composition of this invention. Each test uses a wooden stick having a length of approximately 11 inches and a cross section of approximately 0.014 square inches. In each of Examples 1A, 1B and 1C, a dry or blank untreated stick is secured at one end with a clamp. A candle is placed at the other (or unclamped) end of the stick. The stick is then placed inside the flame of the candle in such a manner that the distance between the center of the flame and the unclamped end of the stick is always constant at 3 inches. In each of Examples 2A, 2B and 2C, a wooden stick is soaked in water for one hour, clamped at one end and positioned in the same manner as described above. In each of Examples 3A, 3B and 3C, a wooden stick is coated with the aqueous suspension fire retardant composition of this invention at a concentration of 63%, clamped at one end and positioned in the manner as described above. When the stick is inside the candle flame, it starts to burn. This burning is accompanied by its twisting and bending downwards until it finally breaks away from the clamped part of the stick. In other words, the broken piece is the 3 inches part of the stick. The burn time is measured from the moment the stick enters the flame until the 3 inches part starts to bend downwards. The results of these tests are set forth in Table I below.

TABLE 1

| | | Burn Time | |
|---|---|---|---|
| Example | Stick Treatment | (Seconds) | Observation |
| 1A | None | 10.35 | Flame advanced horizontally |
| 1B | None | 10.1 | along the wood on both |
| 1C | None | 12.0 | sides of the candle flame |
| | | | burning the wood in its |
| | | | path |
| 2A | Water | 30.0 | Flame advanced horizontally |
| 2B | Water | 29.5 | but to a lesser extent |
| 2C | Water | 32.0 | than the dry blank in |
| | | | Examples 1A, 1B and 1C |
| 3A | Coated | 701.6 | Burning is confined to the |
| 3B | Coated | 687.2 | part of the stick within |
| 3C | Coated | 526.7 | the candle flame, i.e. the |
| | | | flame did not advance |
| | | | horizontally along the |
| | | | wood as it did in Example |
| | | | 1A, 1B and 1C |

### EXAMPLE 4

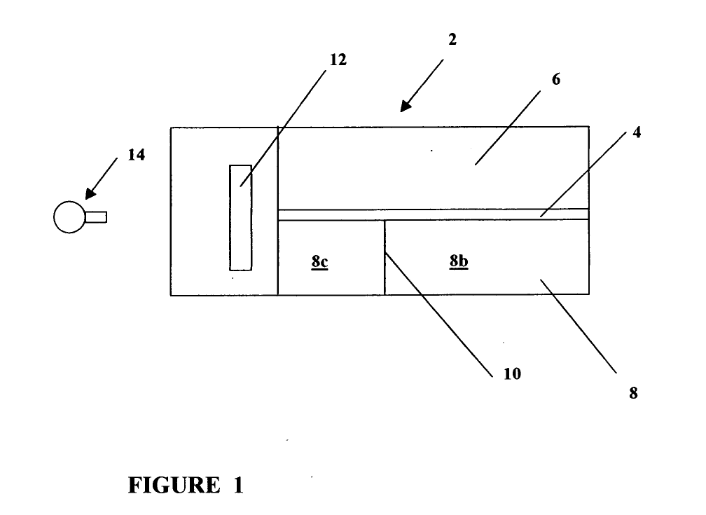

The purpose of this example is to demonstrate the effectiveness of the fire retardant composition of this invention when used in simulated brush fire conditions. Test tray 2, as shown in FIG. 1, is used to create simulated brush fire conditions. Test tray 2 is made of iron and has a perimeter which is about one inch in height. It is divided into region 6 and region 8 by metal barrier 4 which is positioned so that it is perpendicular to the end of the tray. Region 8 contains a second barrier 10 which is perpendicular to barrier 4 and extends from barrier 4 to the side of tray 2 and subdivides region 8 into region 8b and region 8c. Fire trough 12 is situated adjacent to region 6 and region 8c. The dimensions of the tray are approximately 12 inches by 30 inches, the dimensions of regions 6 and 8 are about 6 inches by 24 inches and the dimensions of regions 8b and 8c are about 6 inches by 18 inches and 6 inches by 6 inches, respectively.

In this example, regions 6, 8b and 8c are covered with a layer of standard garden mulch. Approximately 10 cc of the fire retardant composition used in Examples 3A, 3B and 3C is sprinkled on the mulch, in region 8c only. Fire trough 12 is packed with ignitable tree bark and is periodically supplied with a mixture of gasoline and alcohol. The combustible bark is ignited and immediately forms a wall of flames. A stream of air, such as that provided by hand blower 14, simultaneously directs the wall of flames toward the mulch in regions 6 and 8c. The mulch in region 6 becomes ignited and gradually is advanced by the stream of air toward the appropriate end of tray 2 until all of the mulch in region 6 is completely burned. During this period, the mulch in regions 8b and 8c do not ignite and catch fire. The mulch in region 8c, which has been treated with the composition of this invention, forms a protective belt which prevents flame from reaching the mulch in region 8b.

In this example, the mulch simulated brush and the air stream provided by blower 14 simulates wind. The mulch in region 8c treated with the fire retardant composition of this invention simulates an area of brush or wooded area that is similarly treated. The example thus demonstrates the effectiveness of the fire retardant composition in controlling the spread of brush fires and particularly those whose flames are accelerated by windy conditions.

The invention has been described in detail with particular reference to certain preferred embodiments thereof, but it will be understood that variations and modifications can be effected within the spirit and scope of the invention.

1. A fire retardant composition comprising an aqueous suspension of from about 7% to about 35% by weight aluminum.

2. The fire retardant composition of claim 1 wherein the aqueous solution further comprises from about 2% to about 35% by weight boron.

3. The fire retardant composition of claim 1 wherein the material contains from 2%-35% by weight aluminum.

4. The fire retardant composition of claim 2 wherein the fire suppression composition is free of clay.

5. The fire retardant composition of claim 2 wherein the fire suppression composition is free of phosphate.

6. The fire retardant composition of claim 2 wherein the fire suppression composition is free of gypsum.

7. The fire retardant composition of claim 2 wherein the fire suppression composition is free of sulfate.

8. A fire retardant composition comprising an aqueous suspension of from about 2% to about 35% by weight boron.

9. The fire retardant composition of claim 4 wherein the aqueous solution further comprises from about 7% to about 35% aluminum.

10. A method of suppressing fires comprising applying an effective amount of a fire suppression composition comprising a suspension of boron and aluminum to suppress the fire.

11. The method of claim 10 wherein the fire suppression composition comprises an aqueous solution of the boron and the aluminum.

12. The method of claim 11 wherein the fire suppression composition contains 0% clay.

13. The method of claim 11 wherein the fire suppression composition contains 0% phosphate.

14. The method of claim 11 wherein the fire suppression composition contains 0% gypsum.

15. The method of claim 11 wherein the fire suppression composition comprises an aqueous solution of from about 2% to about 35% by weight of the boron and from about 7% to about 35% by weight of the aluminum.

16. The method of claim 15 wherein the aluminum and the boron are applied to a surface of a building structure when the building structure is burning.

17. The method of claim 15 wherein the aluminum and the boron are applied to a surface of a building structure before the building structure is burning.

18. The method of claim 15 wherein the aluminum and the boron are applied to vegetation, wooded area or brush when burning.

19. The method of claim 15 wherein the aluminum and the boron are applied to vegetation, wooded area or brush before burning to prevent the spread of fire.
